(19) United States
(12) Patent Application Publication
(10) Pub. No.: US 2023/0187630 A1
(43) Pub. Date: Jun. 15, 2023

(54) APPARATUS FOR MANUFACTURING CATHODE ACTIVE MATERIAL FOR LITHIUM ION SECONDARY BATTERIES, AND METHOD OF MANUFACTURING CATHODE ACTIVE MATERIAL FOR LITHIUM ION SECONDARY BATTERIES

(71) Applicant: TOYOTA JIDOSHA KABUSHIKI KAISHA, Toyota-shi (JP)

(72) Inventor: Tomohiro YOKOYAMA, Toyota-shi (JP)

(73) Assignee: TOYOTA JIDOSHA KABUSHIKI KAISHA, Toyota-shi, Aichi-ken (JP)

(21) Appl. No.: 17/968,274

(22) Filed: Oct. 18, 2022

(30) Foreign Application Priority Data
Dec. 15, 2021 (JP) 2021-203629

(51) Int. Cl. H01M 4/525; H01M 4/505; F27B 9/14; F27B 9/28; C01G 53/00

(52) U.S. Cl. CPC H01M 4/525; H01M 4/505; F27B 9/145; F27B 9/28; C01G 53/50; H01M 2004/028

(57) ABSTRACT

Provided is apparatus for manufacturing a cathode active material for lithium ion secondary batteries which can improve productivity. The apparatus for manufacturing a cathode active material for lithium ion secondary batteries includes: a conveying device conveying a cathode active material raw material that contains a metallic compound and a lithium compound; and a heating unit adapted to heat the cathode active material raw material, wherein the heating unit has at least one heating roller adapted to heat the cathode active material raw material by heat conduction, and said at least one heating roller has a wrap angle larger than 180° and at most 360°.

### FIELD

The present application relates to apparatus for manufacturing a cathode active material for lithium ion secondary batteries, and a method of manufacturing a cathode active material for lithium ion secondary batteries.

### BACKGROUND

Lithium ion secondary batteries are widely used as power sources for, for example, laptop computers and mobile terminals, and power supplies for driving vehicles. Therefore, it is demanded to improve productivity of lithium ion secondary batteries, and also to improve productivity of cathode active materials for use in lithium ion secondary batteries.

A general method of manufacturing a cathode active material for lithium ion secondary batteries is as follows. First, a cathode active material raw material is obtained by mixing a metal hydroxide including nickel etc., and a lithium compound (such as lithium hydroxide and lithium carbonate) which are to be a precursor. Next, the cathode active material raw material is oxidized by calcination. Specifically, the metal hydroxide is oxidized to a metal oxide, and the lithium compound is oxidized to lithium oxide. Subsequently, a predetermined sagger is filled with the calcined cathode active material raw material, and the raw material is fired therein. A lithium metal oxide that is a cathode active material is obtained by the reaction between the metal oxide and the lithium oxide in the cathode active material raw material, which is caused by the firing. The obtained cathode active material is recovered and utilized for lithium ion secondary batteries. For example, Patent Literatures 1 to 3 disclose such a method of manufacturing a cathode active material.

A firing device such as a rotary kiln is used in the step of calcining the cathode active material raw material. A rotary kiln is a device that enables a cathode active material raw material to be stirred and heated at the same time in an oxidizing atmosphere, so that the oxidation of the cathode active material raw material can be promoted. The reason for calcining the cathode active material raw material is to prevent the temperature irregularity in the cathode active material raw material due to the oxidation reaction between the metal hydroxide and the lithium compound, which is an endothermic reaction, from occurring.

A firing device such as a roller hearth kiln is used in the step of firing the cathode active material raw material. A roller hearth kiln enables the cathode active material raw material to be heated at a higher temperature than in the calcining step, and enables the cathode active material to be manufactured by the reaction between the metal oxide and the lithium oxide in the cathode active material raw material. Pressure may be applied for densifying the cathode active material raw material when the sagger is filled with the cathode active material raw material. The densification of the cathode active material raw material allows the contact area between the metal oxide and the lithium oxide in the cathode active material raw material to increase, which can promote the firing.

### CITATION LIST

### Patent Literature

Patent Literature 1: JP 2020-113429 A
Patent Literature 2: JP 2019-175694 A
Patent Literature 3: JP 2020-198195 A

### SUMMARY

### Technical Problem

A rotary kiln is a device for oxidizing metal hydroxides and/or lithium compounds. Thus, it is necessary to actively feed air or oxygen into a rotary kiln to make the inside of the rotary kiln an oxidizing atmosphere. Such necessity to actively feed air or oxygen into a rotary kiln results in higher production costs.

A roller hearth kiln is a device for firing calcined cathode active material raw materials. For uniform heating, it is necessary to fill a sagger with a cathode active material raw material. However, temperature irregularity easily occurs in the cathode active material raw material according to the way of the hot air flow in the device. Short-term heating in a condition where temperature irregularity occurs in the cathode active material raw material results in variations in the crystallinity of the manufactured cathode active material. Therefore, it is necessary to heat a cathode active material raw material for a long time in order to suppress temperature irregularity when a cathode active material is manufactured with a roller hearth kiln. This however causes production costs to increase. The necessity of long-term heating also requires larger-scale facilities often.

An object of the present application is to provide apparatus for manufacturing a cathode active material for lithium ion secondary batteries, and a method of manufacturing a cathode active material for lithium ion secondary batteries which both can improve productivity.

### Solution to Problem

As one aspect for solving the above problems, the present disclosure is provided with apparatus for manufacturing a cathode active material for lithium ion secondary batteries, the apparatus comprising: a conveying device conveying a cathode active material raw material that contains a metallic compound and a lithium compound, the metallic compound including at least one metallic element selected from the group consisting of nickel, cobalt, and manganese; and a heating unit adapted to heat the cathode active material raw material, wherein the heating unit has at least one heating roller adapted to heat the cathode active material raw material by heat conduction, and said at least one heating roller has a wrap angle larger than 180° and at most 360°.

The apparatus may have the following aspect: in the apparatus, a plurality of the heating rollers are included, some of the heating rollers adapted to heat one surface of the cathode active material raw material, and a rest of the heating rollers adapted to heat another surface of the cathode active material raw material are alternately arranged from an upstream side to a downstream side in a conveying direction, and every two of the heating rollers are arranged as facing each other so as to hold the cathode active material raw material therebetween, said every two being adjacent to each other.

In the heating unit in the apparatus, the cathode active material raw material may be heated to 700° C. to 1000° C. In the heating unit in the apparatus, the cathode active material raw material may be heated in an oxidizing atmosphere.

In the apparatus, the conveying device may have a conveying member made of a porous heat-resistant member, and the cathode active material raw material may be heated with the heating roller via the porous heat-resistant member.

The apparatus may further comprise: a forming member adapted to form the cathode active material raw material into a sheet, the forming member being more upstream in the conveying direction than the heating unit. The apparatus may further comprise: a recovery part adapted to recover a cathode active material obtained in the heating unit.

As one aspect for solving the above problems, the present disclosure is provided with a method of manufacturing a cathode active material for lithium ion secondary batteries, the method comprising: preparing a cathode active material raw material by mixing a metallic compound and a lithium compound, the metallic compound including at least one metallic element selected from the group consisting of nickel, cobalt, and manganese, and obtaining the cathode active material raw material; and heating the cathode active material raw material, wherein in the heating, the cathode active material raw material is conveyed and heated by heat conduction at the same time using at least one heating roller, and said at least one heating roller has a wrap angle larger than 180° and at most 360°.

In the heating in the method, using said at least one heating roller, both surfaces of the cathode active material raw material, and either surface of the cathode active material raw material may be alternately heated.

In the heating in the method, the cathode active material raw material may be heated to 700° C. to 1000° C. In the heating in the method, the cathode active material raw material may be heated in an oxidizing atmosphere. Further, in the heating in the method, the cathode active material raw material may be heated via a porous heat-resistant member.

The method may further comprise: forming the cathode active material raw material into a sheet, prior to the heating. The method may further comprise: recovering a cathode active material obtained in the heating.

### Advantageous Effects

The present disclosure can improve productivity of a cathode active material.

### BRIEF DESCRIPTION OF DRAWINGS

FIG. 1 is a schematic view of apparatus for manufacturing a cathode active material for lithium ion secondary batteries 100;

FIG. 2 illustrates a wrap angle x;

FIG. 3 is an enlarged view of heating rollers 31 and touch rolls 32;

FIG. 4 is a flowchart of a method of manufacturing a cathode active material for lithium ion secondary batteries 1000;

FIG. 5 is a flowchart of a method of manufacturing a cathode active material for lithium ion secondary batteries 2000; and

FIG. 6 is a flowchart of a method of manufacturing a cathode active material for lithium ion secondary batteries 3000.

### DESCRIPTION OF EMBODIMENTS

[Apparatus for Manufacturing Cathode Active Material for Lithium Ion Secondary Batteries]

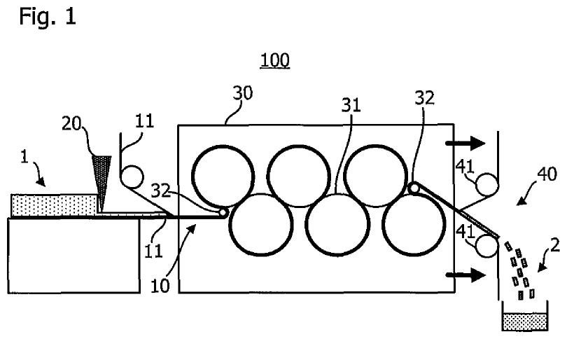

Apparatus for manufacturing a cathode active material for lithium ion secondary batteries according to the present disclosure will be described with reference to apparatus for manufacturing a cathode active material for lithium ion secondary batteries 100 which is one embodiment (may be referred to as “manufacturing apparatus 100” in this description). FIG. 1 shows a schematic view of the manufacturing apparatus 100. Here, the right-left direction in FIG. 1 is defined as a conveying direction, the up-down direction therein is defined as a height direction, and the back-front direction therein is defined as a width direction.

As shown in FIG. 1, the manufacturing apparatus 100 is provided with a conveying device 10, a forming member 20, a heating unit 30, and a recovery part 40. FIG. 1 also shows a cathode active material raw material 1 that is a raw material, and a cathode active material 2 that is a product.

<Cathode Active Material Raw Material 1>

The cathode active material raw material 1 contains a metallic compound and a lithium compound, and may further contain a recycled material such as the cathode active material 2 in a deteriorated and pulverized state. The cathode active material raw material 1 can be fired with high thermal uniformity in the heating unit 30 even if containing the deteriorated cathode active material 2.

The cathode active material raw material 1 can be obtained by mixing these materials. The mixing way is not particularly limited, but a known method may be employed therefor. For example, these materials may be mixed with a mortar or a blender.

(Metallic Compound)

The metallic compound includes at least one metallic element selected from the group consisting of nickel, cobalt, and manganese. The metallic compound may include nickel, may include nickel and cobalt, or may include nickel, cobalt, and manganese. The metallic compound may further include any other metallic element(s). For example, the metallic compound may further include aluminum. The metallic compound may include aluminum instead of manganese.

For example, the molar ratio of the metallic elements of the metallic compound may be Ni:Co:Mn=x:y:z (x=1−y−z, 0≤y<1 and 0≤z<1); or Ni:Co:Al=x:y:z (x=1−y−z, 0≤y<1 and 0≤z<1).

The metallic compound may be a metal hydroxide, a metal oxide, a metal carbonate or a metal perhydroxide. These metallic compounds may be used alone or in combination. The metallic compound is preferably a metal hydroxide or a metal oxide.

Any known metal hydroxide including at least one metallic element selected from the group consisting of nickel, cobalt, and manganese may be used as the metal hydroxide, and examples thereof include NiₓCo_{y}Mn_{z}(OH)_{2+α} (x=1−y−z, 0≤y<1, 0≤z<1 and 0≤α<1), and NiₓCo_{y}Al_{z}(OH)_{2+α} (x=1−y−z, 0≤y<1, 0≤z<1 and 0≤α<1). Any known metal oxide including at least one metallic element selected from the group consisting of nickel, cobalt, and manganese may be used as the metal oxide, and examples thereof include NiₓCo_{y}Mn_{z}(O)_{2+α} (x=1−y−z, 0≤y<1, 0≤z<1 and −1≤α<0), and NiₓCo_{y}Al_{z}(O)_{2+α} (x=1−y−z, 0≤y<1, 0≤z<1 and −1≤α<0).

The metallic compound may be prepared by a known method. The following are an example of the method of preparing the metal hydroxide, and an example of the method of preparing the metal oxide. The method of preparing the metallic compound is not limited to them.

An example of the method of preparing the metal hydroxide is crystallization. Hereinafter an example of the method of preparing the metal hydroxide by crystallization will be described.

First, a metal source solution is prepared by dissolving a Ni source, a Co source, and a Mn source (or an Al source) in an aqueous solvent (e.g., ion-exchanged water). As the metal source, a metallic salt of each metal element (i.e., a Ni salt, a Co salt, and a Mn salt (or an Al salt)) may be used. The type of the metallic salt is not particularly limited, but any known metallic salt such as a hydrochloride, a sulfate, a nitrate, a carbonate, and a hydroxide may be used. These metal sources are added to the aqueous solvent in no particular order. One may separately prepare aqueous solutions of the metal sources, and mix them. The ratio of the metal sources is suitably adjusted so that a desired metal hydroxide can be obtained.

Next, the metal source solution and an aqueous solution of NH₃ are dropped into an alkaline aqueous solution in an inert atmosphere while the alkaline aqueous solution is stirred. For example, an aqueous sodium hydroxide may be used as the alkaline aqueous solution. The pH of the alkaline aqueous solution is set in, for example, 11 to 13. The aqueous solution of NH₃ is dropped while the concentration thereof is kept in the range of, for example, 5 g/L to 15 g/L. As the metal source solution and the aqueous solution of NH₃ are dropped into the alkaline aqueous solution, the pH of the resultant solution gradually decreases. Thus, one may additionally drop an alkaline aqueous solution suitably to keep the pH in a predetermined range.

After a certain period of time has passed, the resultant is subjected to vacuum filtration, and the settling is recovered. The metal hydroxide is obtained by washing and drying the obtained settling. The settling may be washed plural times. The settling may be dried by air or by heating. The settling may be dried by heating at, for example, 120 to 300° C. The drying time is, for example, 6 to 18 hours.

The metal oxide may be prepared by, for example, subjecting the metal hydroxide to oxidizing roasting. Oxidizing roasting here is to heat the metal hydroxide in an oxidizing atmosphere. The heating temperature is not particularly limited as long as the metal hydroxide can be converted into the metal oxide thereat, but is, for example, 700° C. to 800° C. The heating time is not particularly limited as long as the metal hydroxide can be converted into the metal oxide therefor, but is, for example, 0.5 hours to 3 hours. Such heating may be carried out using a firing device such as a rotary kiln.

The mean particle diameter of the metallic compound is not particularly limited, but is, for example, in the range of 1 μm to 1 mm. In this description, “mean particle diameter” is a median diameter that is a particle diameter at the 50% integrated value in the volume-based particle diameter distribution obtained by the laser diffraction and scattering method.

The content of the metallic compound in the cathode active material raw material is suitably set so that a desired cathode active material can be obtained.

(Lithium Compound)

The lithium compound is not particularly limited as long as being a compound including lithium. A known lithium compound may be used, and examples thereof include lithium oxide, lithium hydroxide, lithium nitrate, and lithium carbonate. Lithium hydroxide, lithium nitrate, lithium carbonate, and the like each become lithium oxide by oxidation.

The type of the lithium compound is suitably selected according to the type of the metallic compound because the heating temperature (firing temperature) is changed according to the type of the metallic compound. For example, a case where a metal hydroxide or a metal oxide including nickel, cobalt, and manganese is used as the metallic compound needs the firing temperature at approximately 800° C. Therefore, in this case, lithium carbonate is preferably selected as the lithium compound. A case where a metal hydroxide or a metal oxide including nickel, cobalt, and aluminum is used as the metallic compound needs the firing temperature at approximately 500° C. Therefore, in this case, lithium hydroxide is preferably selected as the lithium compound.

The content of the lithium compound in the cathode active material raw material is suitably set so that a desired cathode active material can be obtained.

(Shape of Cathode Active Material Raw Material 1)

The shape of the cathode active material raw material 1 is not particularly limited, but may be a sheet. The cathode active material raw material 1 in the form of a sheet is easy to be uniformly heated through. As a result, nonuniform heating is suppressed, and variations in the crystallinity of the cathode active material 2 to be produced are also reduced. The cathode active material raw material 1 in the form of a sheet is also easy to be pulverized at the recovery part 40.

The thickness of the cathode active material raw material 1 in the form of a sheet is not particularly limited, but for example, may be at least 0.1 mm, at least 0.5 mm, at least 1 mm, at least 2 mm, at most 50 mm, at most 30 mm, less than 30 mm, at most 20 mm, at most 10 mm, or at most 5 mm. The cathode active material raw material 1 in the form of a sheet having too large a thickness is difficult to be uniformly heated. The cathode active material raw material 1 in the form of a sheet having too small a thickness causes productivity to lower.

The cathode active material raw material 1 may be formed into a sheet with the forming member 20 and/or heating rollers 31, or may be formed into a sheet by, for example, press molding in advance. One may form the cathode active material raw material 1 into a sheet in advance, and further form the cathode active material raw material 1 with the forming member 20 and/or the heating rollers 31 so that the cathode active material raw material 1 will have a predetermined thickness.

<Conveying Device 10>

The conveying device 10 is a member for conveying the cathode active material raw material 1. As in FIG. 1, the conveying device 10 is provided with a conveying member 11 that conveys the cathode active material raw material 1, and a driving unit (not shown) for driving the conveying member 11.

(Conveying Member 11)

The conveying member 11 is a member (conveyor) that conveys the cathode active material raw material 1. The conveying member 11 is a member in the form of a sheet, and is driven by the driving unit from the upstream side toward the downstream side in the conveying direction. It is necessary for the conveying member 11 to be arranged on the lower surface of the cathode active material raw material 1 because the conveying member 11 conveys the cathode active material raw material 1 as the cathode active material raw material 1 is put thereon. The conveying member 11 may be also arranged on the upper surface of the cathode active material raw material 1 as shown in FIG. 1. In other words, the cathode active material raw material 1 may be conveyed as sandwiched in the conveying member 11.

As described later, the manufacturing apparatus 100 is to heat the cathode active material raw material 1 by contact heating. The cathode active material raw material 1 may be therefore heated by direct contact with the heating rollers 31. This however causes the cathode active material raw material 1 to adhere to the heating rollers 31, which causes productivity to lower. Then, in the manufacturing apparatus 100, adhering the cathode active material raw material 1 to the heating rollers 31 is suppressed by bringing the heating rollers 31 into contact with the cathode active material raw material 1 via the conveying member 11. For such a reason, the cathode active material raw material 1 may be conveyed as sandwiched in the conveying member 11 when the upper and lower surfaces of the cathode active material raw material 1 are heated.

It is necessary to make the conveying member 11 out of a member resistant to the heating temperature in the heating unit 30 (heat-resistant member) because the conveying member 11 is to be in contact with the heating rollers 31. For example, it is necessary for the heat-resistant member to be resistant to a temperature of 900° C. or higher. Examples of such a heat-resistant member include quartz cloths and silica fiber cloths.

Here, it is necessary to take in oxygen from the outside in order to progress firing of the cathode active material raw material 1 when a material that becomes an oxide by the oxidation of the metal hydroxide, a lithium hydroxide, etc. is contained in the cathode active material raw material 1. Meanwhile, the cathode active material raw material 1 may generate a gas such as moisture (water vapor) and carbon dioxide by firing. Therefore, the cathode active material raw material 1 is preferably fired in an environment where gases can be exchanged. Thus, the conveying member 11 may be made of a porous heat-resistant member that can lead to an efficient gas exchange with the outside. The pore size of the porous heat-resistant member is not particularly limited as long as an efficient gas exchange can be performed through the pores, and as long as the cathode active material raw material 1 does not leak to the outside through the pores. For example, the pore size of the porous heat-resistant member may be at most 20 μm, at most 10 μm, at most 5 μm, at least 3 μm, at least 1 μm, or at least 0.5 μm. The porous heat-resistant member having too large a pore size causes the cathode active material raw material 1 to easily leak to the outside. The porous heat-resistant member having too small a pore size causes the efficiency of the gas exchange with the outside to lower. Examples of such a porous heat-resistant member include fibrous heat-resistant members. Examples of the fibrous heat-resistant member include quartz cloths and silica fiber cloths.

Here, the pore size of the porous heat-resistant member means a diagonal length of a mesh opening obtained by the fiber diameter and the product density (unit: number of fibers/mm).

<Forming Member 20>

The forming member 20 is a member to form the cathode active material raw material 1 into a sheet. As shown in FIG. 1, the forming member 20 is arranged on the upstream side of the heating unit 30 in the conveying direction. In the manufacturing apparatus 100, the forming member 20 is an optional member because the cathode active material raw material 1 may be formed into a sheet in advance as described above.

An example of the forming member 20 is a powder amount controlling member to control the powder amount of the cathode active material raw material 1 to be conveyed, to form the cathode active material raw material 1 into a sheet. Examples of the powder amount controlling member include a powder amount controlling knife shown in FIG. 1, and any member to press and form the cathode active material raw material 1 into a sheet.

The thickness of the cathode active material raw material 1 in the form of a sheet which is formed with the forming member 20 is not particularly limited, but for example, may be at least 0.1 mm, at least 0.5 mm, at least 1 mm, at least 2 mm, at most 50 mm, at most 30 mm, less than 30 mm, at most 20 mm, at most 10 mm, or at most 5 mm.

<Heating Unit 30>

The heating unit 30 is to heat (fire) the cathode active material raw material 1. As shown in FIG. 1, the heating unit 30 is a rectangular housing, and is provided with the six heating rollers 31 thereinside. The heating unit 30 is also provided with touch rolls 32 at positions next to the heating rollers 31 on the respective upstream and downstream sides in the conveying direction.

The cathode active material raw material 1 may be heated in the heating unit 30 to at least 700° C., at least 800° C., at least 900° C., at most 1100° C., or at most 1000° C. The skilled person can set the temperature so that the cathode active material raw material 1 can be suitably fired. As described later, the cathode active material raw material 1 is heated by the contact thereof with the heating rollers 31. Therefore, actually, the heating rollers 31 are each heated to a predetermined temperature. The heating rollers 31 may be each heated to the same or different temperature(s). For example, some of the heating rollers 31 arranged on a more upstream side in the conveying direction may be heated to a lower temperature for the purpose of oxidation, and some of the heating rollers 31 arranged on a more downstream side in the conveying direction may be heated to a higher temperature for the purpose of firing.

The cathode active material raw material 1 may be heated in an oxidizing atmosphere in the heating unit 30 because the oxidation reaction of the cathode active material raw material 1 is promoted. The heating unit 30 is provided with an air blowing part (not shown) in order to make the inside thereof an oxidizing atmosphere. The supply of air or oxygen from the air blowing part to the inside of the heating unit 30 can keep the inside of the heating unit 30 in an oxidizing atmosphere. Air or oxygen may be continuously supplied so as to keep the inside of the heating unit 30 in a negative pressure. For example, a known blower may be used as the air blowing part. When the cathode active material raw material does not contain any material that causes an oxidation reaction, it is not necessary to make the inside of the heating unit 30 an oxidizing atmosphere because it is not necessary to oxidize the cathode active material raw material 1 in the heating unit 30.

Here, in this description, “oxidizing atmosphere” is an atmosphere that allows a target material to be oxidized, and is, for example, an atmosphere of a space to which a gas containing at least 1% oxygen (e.g., air or oxygen) is supplied, and which is thus filled with the gas. The oxygen concentration in the space may be suitably set according to the speed at which the oxidation of the target material progresses.

(Heating Rollers 31)

The heating rollers 31 are members to heat the cathode active material raw material 1 by heat conduction. “To heat the cathode active material raw material 1 by heat conduction” means what is called contact heating, that is, to heat the cathode active material raw material 1 by bringing the heating rollers 31 into direct or indirect contact with the cathode active material raw material 1. “Indirect” means to heat the cathode active material raw material 1 by bringing the heating rollers 31 into contact with the cathode active material raw material 1 via any other member(s). In FIG. 1, the cathode active material raw material 1 is heated by bringing the heating rollers 31 into contact therewith via the conveying member 11. The cathode active material raw material 1 may be heated by bringing the heating rollers 31 into contact therewith via (a) member(s) other than the conveying member 11, or via the conveying member 11 and any other member(s). In this description, “direct or indirect contact” may be simply referred to as “contact” unless otherwise mentioned.

The heating rollers 31 are to heat the cathode active material raw material 1 by contact heating, and features thereof are that a contacted portion can be efficiently heated, and that the thermal uniformity of the contacted portion is high. Accordingly, the time for firing the cathode active material raw material 1 can be shortened, and variations in crystallinity can be reduced. Conventionally, the two heating steps of a calcining step and a firing step are required for manufacturing a cathode active material because contact heating leads to high thermal uniformity. With the manufacturing apparatus 100, the cathode active material can be obtained by firing the cathode active material raw material in one step. Therefore, according to the manufacturing apparatus 100, the productivity of the cathode active material can be improved. A shortened heating time also allows facilities to be smaller.

The cathode active material raw material 1 can be conveyed and heated at the same time by use of the heating rollers 31. This allows the cathode active material 2 to be continuously manufactured.

As shown in FIG. 1, the heating unit 30 is provided with the six heating rollers 31. The aspect of the arrangement of the heating rollers 31, and the number thereof are not particularly limited. As shown in FIG. 1, the heating rollers to heat one surface (e.g., the upper surface) of the cathode active material raw material 1, and the heating rollers to heat the other surface (e.g., the lower surface) thereof may be alternately arranged from the upstream side to the downstream side in the conveying direction. This allows both the surfaces of the cathode active material raw material 1 to be equally heated. Thus, the temperature irregularity in the cathode active material raw material 1 is suppressed.

Every two of the heating rollers 31 which are adjacent to each other may be arranged as facing each other so as to hold the cathode active material raw material 1 therebetween. This allows both the surfaces of the cathode active material raw material 1 to be heated at the same time. Thus, heating efficiency can be improved, and temperature irregularity can be suppressed. The arrangement of every two of the heating rollers 31 adjacent to each other as said every two heating rollers 31 face each other allows the cathode active material raw material 1 to be heated as pressure is applied. In other words, the cathode active material raw material 1 can be hot-formed into a sheet. The thickness of the cathode active material raw material 1 in the form of a sheet can be adjusted by adjusting the gaps between the facing heating rollers 31. For example, the gaps between the facing heating rollers 31 may be each gradually narrowed from the upstream side to the downstream side in the conveying direction. This can lead to the heating rollers 31 arranged so that the heating rollers 31 can surely hold the cathode active material raw material 1 therebetween. Thus, the temperature irregularity in the cathode active material raw material 1 is suppressed. It is not necessary to strictly adjust the gaps between the heating rollers 31 because the purpose of the heating rollers 31 is not to form the cathode active material raw material 1.

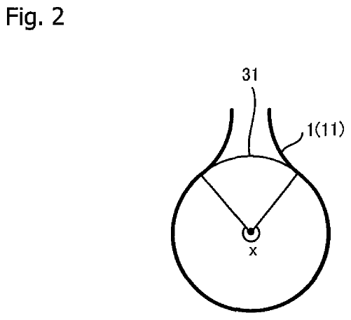

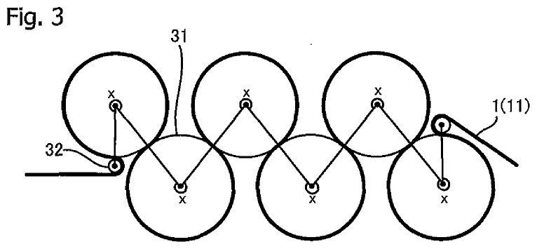

Each of the heating rollers 31 is arranged as facing each other, and a predetermined wrap angle is set therefor. FIG. 2 illustrates the wrap angle. FIG. 3 is an enlarged view of the heating rollers 31 and the touch rolls 32 in FIG. 1.

As indicated by “x” in FIGS. 2 and 3, “wrap angle” is a center angle of each of the heating rollers 31 which is obtained using the extent of each of the heating rollers 31 from a place which the cathode active material raw material 1 (conveying member 11) touches, to a place where the cathode active material raw material 1 separates from each of the heating rollers 31. Setting the wrap angle x for each of the heating rollers 31 as in FIG. 2 can lead to an increased contact area between the heating rollers 31 and the cathode active material raw material 1, and improved heating efficiency. In addition, nonuniform heating is suppressed and a gas exchange can be promoted because the cathode active material raw material 1 can be drawn to be moved. The adhesion of the cathode active material raw material 1 to the heating rollers 31 can be also suppressed. While firing of the cathode active material raw material 1 progresses due to heating of both the surfaces of part of the cathode active material raw material 1, which is held between the heating rollers 31 arranged as facing each other, another part of the cathode active material raw material 1 which is not held between the heating rollers 31 but is in contact with the heating rollers 31 on one side is heated from a contact face thereof, and at the same time a gas exchange can be performed via an open face of the other part of the cathode active material raw material 1 which is not in contact with the heating rollers 31. Thus, firing of the cathode active material raw material 1 can be promoted. Therefore, both the surfaces of the cathode active material raw material 1, and either surface thereof can be alternately heated (hot-formed in terms of both the surface) by the arrangement of the heating rollers 31 as in FIGS. 1 and 3. According to this, heating and an efficient gas exchange are alternately performed, and thus firing is promoted.

The wrap angle x of each of the heating rollers 31 is larger than 180° and at most 360°. The wrap angle x larger than 180° causes the cathode active material raw material 1 to be conveyed in the height direction. Thus, tumbling of the cathode active material raw material 1 is promoted in the conveying, thermal uniformity is improved, and a gas exchange is promoted. This suppresses uneven oxidizing of the cathode active material 2, which is a product, to improve the quality. This also makes it possible to lengthen the time period when the heating rollers 31 and the cathode active material raw material 1 are in contact with each other, which allows facilities to be smaller. Therefore, the productivity in manufacturing the cathode active material 2 can be improved compared with the case where the wrap angle x is at most 180°. The wrap angle x may be at least 210°, at least 240°, at least 270°, at least 300°, smaller than 360°, at most 350°, and at most 330°.

The wrap angle x can be set according to the aspect of arranging the heating rollers 31 and the touch rolls 32. In FIGS. 1 and 3, the heating rollers 31 are each arranged so that the wrap angles can be each a predetermined wrap angle x. Such an arrangement can lead to the wrap angle x of each of the heating rollers 31 set in a predetermined value except the most upstream and most downstream heating rollers 31. The touch rolls 32 are arranged at positions next to the heating rollers 31 on the upstream and downstream sides in the conveying direction. This can lead to the wrap angles of the most upstream and most downstream heating rollers 31 set in predetermined values.

As shown in FIG. 3, the heating rollers 31 are arranged so that the straight line connecting the centers of any two of the heating rollers 31 which are adjacent to each other overlaps one of the straight lines that form the wrap angle of any of said any two heating rollers. This can lead to the cathode active material raw material 1 always in contact with the heating rollers 31, can improve heating efficiency, and can shorten the heating time.

The material of the heating rollers 31 is not particularly limited. For example, the heating rollers 31 may be made from a material that is resistant to a temperature of 1000° C. or higher. Examples of such a material include inorganic materials such as ceramics, and metallic materials such as iron.

The rotation direction of the heating rollers may be in normal rotation (rotation in the same direction as the conveying direction), or in reverse rotation (rotation in the direction opposite to the conveying direction). The rotation number of the heating rollers is not particularly limited. The skilled person may suitably select an optimum rotation direction in which, and an optimum rotation number at which both thermal uniformity and economic efficiency are achieved.

The surfaces of the heating rollers 31 may have roughness. The surfaces of the heating rollers 31 in a rough form enable the cathode active material raw material 1 in contact with the heating rollers 31 to be drawn to be moved, can suppress nonuniform heating, and can promote a gas exchange. The adhesion of the cathode active material raw material 1 to the heating rollers can be also suppressed.

The length of the heating rollers 31 in the width direction is not particularly limited, but, for example, may be set in the same length as the length of the conveying member 11 in the width direction. The diameter of the heating rollers 31 is suitably set in view of the size of the heating unit 30, and in view of suitable heating of the cathode active material raw material 1.

(Touch Rolls 32)

The touch rolls 32 are arranged at respective positions next to the heating rollers 31 on the upstream and downstream sides in the conveying direction. As described above, the touch rolls 32 are used for setting the wrap angles of the heating rollers 31 next thereto. The touch rolls 32 may be arranged at positions opposite to the heating rollers 31 next thereto.

In the manufacturing apparatus 100, the touch rolls 32 are optional members. The numbers of the touch rolls 32 may be at least one. Further, the positions of the touch rolls 32 are not particularly limited as long as the touch rolls 32 are arranged at positions next to the heating rollers 31 for which the wrap angles are to be set using these touch rolls 32.

The material of the touch rolls 32 is not particularly limited, but, for example, can be appropriately selected from materials for the heating rollers 31. The length of the touch rolls 32 in the width direction is not particularly limited, but, for example, may be set in the same length as the length of the conveying member 11 in the width direction. The diameter of the touch rolls 32 may be appropriately set based on the size of the heating unit 30, and the wrap angles of the heating rollers 31.

<Recovery Part 40>

The recovery part 40 is a member to recover the cathode active material 2 obtained in the heating unit 30. When the cathode active material 2 is sandwiched in and conveyed by the conveying member 11 as in FIG. 1, one may separate the conveying member at the recovery part 40, and recover the cathode active material 2 from the inside of the conveying member. In order to separate the conveying member 11 like this, predetermined rollers 41 may be appropriately arranged. The recovered cathode active material 2 may be pulverized. The way of pulverizing the cathode active material 2 is not particularly limited. The cathode active material 2 may be pulverized with, for example, a hammer after the recovery. When the cathode active material raw material 1 is in the form of a sheet, the obtained cathode active material 2 is also in the form of a sheet, and thus can be easily pulverized. For example, the cathode active material 2 pulverizes just as a result of recovery thereof as in FIG. 1.

When the porous heat-resistant member is used for the conveying member 11, the cathode active material 2 is sometimes buried in internal pores. In such a case, the cathode active material 2 buried inside can be recovered by vibrating the conveying member 11 in a condition where the conveying member 11 is turned over, or by blowing air against a surface not in contact with the cathode active material 2 (the arrows in FIG. 1), to improve productivity. An example of a device with which the vibration is imposed is a vibration knocker. An example of a device with which air is blown is an air blower.

<Cathode Active Material 2>

The cathode active material 2 obtained in the manufacturing apparatus 100 has composition of lithium and the metal oxide into which lithium is inserted. For example, the molar ratio of the metallic elements of the cathode active material 2 may be Li:Ni:Co:Mn=s:x:y:z (0.8≤s≤1.2, x=1−y−z, 0≤y<1 and 0≤z<1); or Li:Ni:Co:Al=s:x:y:z (0.8≤s≤1.2, x=1−y−z, 0≤y<1 and 0≤z<1). The composition of the cathode active material 2 may be LiₛNiₓCo_{y}Mn_{z}(O)_{2+α} (0.8≤s≤1.2, x=1−y−z, 0≤y<1, 0≤z<1 and −0.5≤α<0.5); or LiₛNiₓCo_{y}Al_{z}(O)_{2+α} (0.8≤s≤1.2, x=1−y−z, 0≤y<1, 0≤z<1 and −0.5≤α<0.5).

Variations in the crystallinity of the obtained cathode active material 2 are reduced because the cathode active material raw material 1 is fired by contact heating. Variations in crystallinity are obtained by crystallite size determination with XRD. The optimum range of the crystallite size (unit: nm) is set in view of the evaluation result of a battery including the cathode active material 2. For example, the range of the crystallite size may be approximately ±200 nm, ±100 nm, or ±50 nm.

(Supplementary)

In the manufacturing apparatus 100, a plurality of the heating rollers 31 are used. The manufacturing apparatus according to the present disclosure is not limited to this. It is sufficient that at least one heating roller is included because it is sufficient that the heating roller(s) of the minimum number necessary for firing the cathode active material raw material 1 is installed. In the manufacturing apparatus according to the present disclosure, it is sufficient that at least one heating roller may have a wrap angle larger than 180° and at most 360°. This causes the effect of improving productivity to be exerted. The larger the number of the heating rollers having a wrap angle larger than 180° and at most 360° is, the more the effect of improving productivity improves. Therefore, the wrap angles of all the heating rollers may be set to be larger than 180° and at most 360°.

[Method for Manufacturing Cathode Active Material for Lithium Ion Secondary Batteries]

The method of manufacturing a cathode active material for lithium ion secondary batteries according to the present disclosure will be described with reference to a method of manufacturing a cathode active material for lithium ion secondary batteries 1000 which is one embodiment (may be referred to as “manufacturing method 1000” in this description).

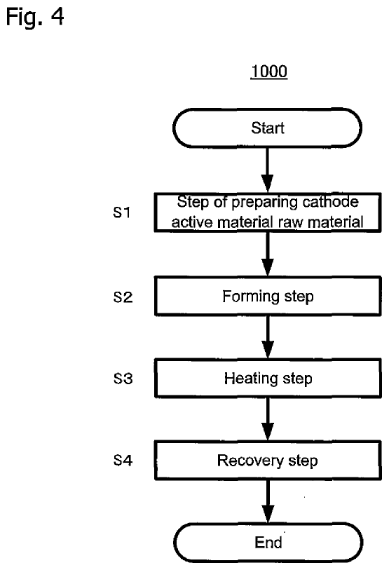

FIG. 4 shows a flowchart of the manufacturing method 1000. As in FIG. 4, the manufacturing method 1000 includes a step S1 of preparing a cathode active material raw material, a forming step S2, a heating step S3 and a recovery step S4. The forming step S2, the heating step S3 and the recovery step S4 can be performed with the manufacturing apparatus according to the present disclosure.

(Step S1 of Preparing Cathode Active Material Raw Material)

The step S1 of preparing a cathode active material raw material is a step of mixing a metallic compound and a lithium compound, and obtaining a cathode active material raw material. Here, the metallic compound, the lithium compound, and the cathode active material raw material are as described above, and thus the description thereof is omitted here. The mixing way is also as described above, and thus the description thereof is omitted here.

<Forming Step S2>

The forming step S2 is an optional step, and is provided prior to the heating step S3. The forming step S2 is a step of forming the cathode active material raw material into a sheet. The way of forming the cathode active material raw material into a sheet is not particularly limited. For example, any of the above-described forming ways may be employed.

<Heating Step S3>

The heating step S3 is a step of heating (firing) the cathode active material raw material. Specifically, the heating step S3 is a step of heating the cathode active material raw material by heat conduction. The way of heating the cathode active material raw material is as described above, and thus the description thereof is omitted here.

<Recovery Step S4>

The recovery step S4 is a step of recovering the cathode active material obtained in the heating step S3. The way of recovering the cathode active material is not particularly limited. For example, any of the above-described recovering ways may be employed.

### OTHER EMBODIMENTS

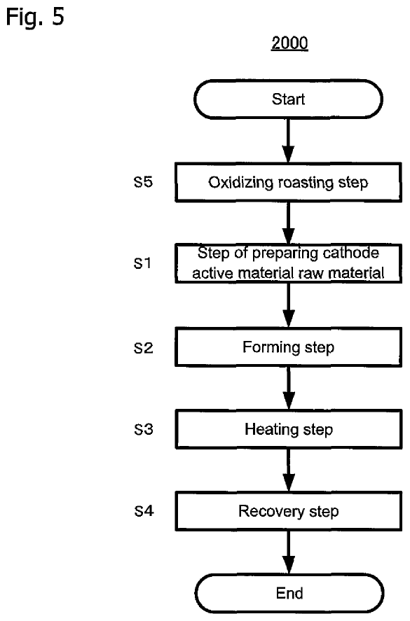

FIG. 5 shows a method of manufacturing a cathode active material for lithium ion secondary batteries 2000 (may be referred to as “manufacturing method 2000” in this description). In the manufacturing method 2000, an oxidizing roasting step S5 is provided in the manufacturing method 1000. The oxidizing roasting step S5 is provided prior to the step S1 of preparing a cathode active material raw material, and is a step of heating a metal hydroxide in an oxidizing atmosphere. The way of subjecting a metal hydroxide to oxidizing roasting is as described above, and thus the description thereof is omitted here. The provision of the oxidizing roasting step S5 enables a metal oxide to be obtained. Oxidation of a metal hydroxide is an endothermic reaction. Thus, use of a cathode active material raw material containing a metal hydroxide in the heating step S3 may cause temperature irregularity. Therefore, in the manufacturing method 2000, the oxidizing roasting step S5 is provided, and the oxidation of the metal hydroxide is performed in advance. It is noted that temperature irregularity is suppressed even if the cathode active material raw material containing a metal hydroxide is used because contact heating is employed in the heating step S3.

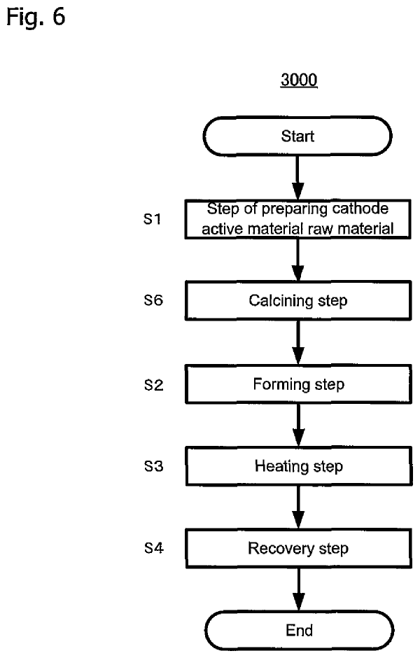

FIG. 6 shows a method of manufacturing a cathode active material for lithium ion secondary batteries 3000 (may be referred to as “manufacturing method 3000” in this description). In the manufacturing method 3000, a calcining step S6 is provided prior to the forming step S2. The calcining step S6 is a step of heating the cathode active material raw material in an oxidizing atmosphere. The calcining step S6 enables a metal hydroxide to be oxidized to a metal oxide, and the lithium compound such as a lithium hydroxide to be oxidized to lithium oxide. Such an oxidation reaction is an endothermic reaction. Thus, the completion of the oxidation of the cathode active material raw material in the calcining step S6 can suppress temperature irregularity in the cathode active material raw material in the heating step S3, and permits short-term firing. It is noted that the cathode active material can be obtained by suitably firing the cathode active material raw material containing a metal hydroxide etc. even if the calcining step S6 is not provided because contact heating is employed in the heating step S3.

The heating temperature in the calcining step S6 is, for example, 700° C. to 800° C. The heating time is, for example, 0.5 hours to 3 hours. Such heating may be carried out using a firing device such as a rotary kiln.

In the manufacturing method according to the present disclosure, both the oxidizing roasting step S5 and the calcining step S6 may be combined.

The apparatus for manufacturing a cathode active material for lithium-ion secondary batteries, and the method of manufacturing a cathode active material for lithium-ion secondary batteries according to the present disclosure have been each described using the embodiments. In the present disclosure, contact heating of heating the cathode active material raw material by heat conduction is employed. The features of contact heating are that a contacted portion can be efficiently heated, and that the temperature irregularity in the contacted portion is slight (the thermal uniformity of the contacted portion is high). Therefore, the present disclosure, where contact heating is employed, can shorten the time for firing the cathode active material raw material, and can suppress variations in crystallinity. In addition, the present disclosure makes it possible to obtain the cathode active material by firing the cathode active material raw material with one heating unit (heating step), which is different from conventional apparatus or a conventional method. Further, a shortened heating time also allows facilities to be smaller.

In addition, in the present disclosure, the wrap angle x of at least one heating roller is set to be larger than 180° and at most 360°. This causes the cathode active material raw material to be conveyed in the height direction. Thus, tumbling of the cathode active material raw material is promoted in the conveying, thermal uniformity is improved, and a gas exchange is promoted. This suppresses uneven oxidizing of the cathode active material, which is a product, to improve the quality. This also makes it possible to lengthen the time period when the heating roller(s) and the cathode active material raw material are in contact with each other, which allows facilities to be further smaller.

The present disclosure thus can improve the productivity in manufacturing the cathode active material.

### INDUSTRIAL APPLICABILITY

The cathode active material manufactured according to this disclosure may be used for a cathode for any of a nonaqueous lithium-ion secondary battery, an aqueous lithium-ion secondary battery, and an all-solid-state lithium-ion secondary battery.

### REFERENCE SIGNS LIST

1 cathode active material raw material
2 cathode active material
10 conveying device
11 conveying member
20 forming member
30 heating unit
31 heating roller
32 touch roll
40 recovery part
41 roller
100 apparatus for manufacturing a cathode active material for lithium ion secondary batteries

What is claimed is:

1. Apparatus for manufacturing a cathode active material for lithium ion secondary batteries, the apparatus comprising:
a conveying device conveying a cathode active material raw material that contains a metallic compound and a lithium compound, the metallic compound including at least one metallic element selected from the group consisting of nickel, cobalt, and manganese; and
a heating unit adapted to heat the cathode active material raw material, wherein
the heating unit has at least one heating roller adapted to heat the cathode active material raw material by heat conduction, and
said at least one heating roller has a wrap angle larger than 180° and at most 360°.

2. The apparatus according to claim 1, wherein
a plurality of the heating rollers are included,
some of the heating rollers adapted to heat one surface of the cathode active material raw material, and a rest of the heating rollers adapted to heat another surface of the cathode active material raw material are alternately arranged from an upstream side to a downstream side in a conveying direction, and
every two of the heating rollers are arranged as facing each other so as to hold the cathode active material raw material therebetween, said every two being adjacent to each other.

3. The apparatus according to claim 1, wherein in the heating unit, the cathode active material raw material is heated to 700° C. to 1000° C.

4. The apparatus according to claim 1, wherein in the heating unit, the cathode active material raw material is heated in an oxidizing atmosphere.

5. The apparatus according to claim 1, wherein
the conveying device has a conveying member made of a porous heat-resistant member, and
the cathode active material raw material is heated with the heating roller via the porous heat-resistant member.

6. The apparatus according to claim 1, further comprising:
a forming member adapted to form the cathode active material raw material into a sheet, the forming member being more upstream in the conveying direction than the heating unit.

7. The apparatus according to claim 1, further comprising:
a recovery part adapted to recover a cathode active material obtained in the heating unit.

8. A method of manufacturing a cathode active material for lithium ion secondary batteries, the method comprising:
preparing a cathode active material raw material by mixing a metallic compound and a lithium compound, the metallic compound including at least one metallic element selected from the group consisting of nickel, cobalt, and manganese, and obtaining the cathode active material raw material; and
heating the cathode active material raw material, wherein
in the heating, the cathode active material raw material is conveyed and heated by heat conduction at the same time using at least one heating roller, and
said at least one heating roller has a wrap angle larger than 180° and at most 360°.

9. The method according to claim 8, wherein
in the heating, using said at least one heating roller, both surfaces of the cathode active material raw material, and either surface of the cathode active material raw material are alternately heated.

10. The method according to claim 8, wherein in the heating, the cathode active material raw material is heated to 700° C. to 1000° C.

11. The method according to claim 8, wherein in the heating, the cathode active material raw material is heated in an oxidizing atmosphere.

12. The method according to claim 8, wherein in the heating, the cathode active material raw material is heated via a porous heat-resistant member.

13. The method according to claim 8, further comprising:
forming the cathode active material raw material into a sheet, prior to the heating.

14. The method according to claim 8, further comprising:
recovering a cathode active material obtained in the heating.
